(19) United States
(12) Patent Application Publication
(10) Pub. No.: US 2026/0121288 A1
(43) Pub. Date: Apr. 30, 2026

(54) METHODS FOR ELIMINATING COUPLING EFFECTS BETWEEN MAIN BEAMS AND SYNTHESIZED BEAMS IN RADIO INTERFEROMETRIC ARRAYS

(71) Applicant: GUIZHOU UNIVERSITY, Guiyang (CN)

(72) Inventors: Li ZHANG, Guiyang (CN); Ming ZHANG, Guiyang (CN); Long XU, Guiyang (CN); Shuai MA, Guiyang (CN); Yousuo DONG, Guiyang (CN)

(73) Assignee: GUIZHOU UNIVERSITY, Guiyang (CN)

(21) Appl. No.: 19/433,046

(22) Filed: Dec. 25, 2025

(30) Foreign Application Priority Data
Oct. 15, 2024 (CN) 202411436232.1

(51) Int. Cl. H01Q 1/52

(52) U.S. Cl. CPC H01Q 1/523

(57) ABSTRACT

Provided is a method for eliminating a coupling effect between a main beam and a synthesized beam in a radio interferometric array is provided, comprising: constructing a residual processing module to process an input image containing effects and obtain information Fₒᵤₜ of the input image; constructing an encoder within a segmentation network, to perform multi-level feature extraction on the input image, and perform further feature extraction for a highest-level feature by using a DH-ASPP module to obtain DH-ASPPₒᵤₜ output from the DH-ASPP module; constructing a decoder within the segmentation network, to fuse low-level features output from the encoder with the high-level feature DH-ASPPₒᵤₜ to obtain Decoderₒᵤₜ output from the decoder; and combining the Fₒᵤₜ with the Decoderₒᵤₜ and using an activation function Tanh to obtain an output of a RpDH-Deeplab network, parameters of the RpDH-Deeplab network being updated iteratively to correct a main beam effect and a synthesized beam effect.

### TECHNICAL FIELD

The present disclosure relates to the field of radio astronomy imaging, and in particular, relates to a method for eliminating a coupling effect between a main beam and a synthesized beam in a radio interferometric array.

### BACKGROUND

The Radio Interferometer Measurement Equation (RIME) reveals the presence of Direction-Dependent Effects (DDEs) and Direction-Independent Effects (DIEs) in radio observations. Precise calibration of both the DDEs and the DIEs is a prerequisite for radio astronomical imaging. For the DIEs, traditional Second Generation Calibration (2GC) methods, which include self-calibration, can achieve satisfactory calibration. However, 2GC methods are no longer adequate for the more complex DDEs. Consequently, Third Generation Calibration (3GC) methods are required to correct for the DDEs, representing a current research trend. A main beam effect constitutes a major part of DDEs. Furthermore, a synthesized beam effect also exists during observation. The effectiveness of correcting a coupling effect between the main beam and the synthesized beam directly impacts the imaging quality of radio astronomical observations.

Although various calibration methods have been applied to radio interferometric arrays, their imaging performance remains susceptible to the influence of the coupling effect between the main beam and the synthesized beam. This is particularly true for observations of mixed and extended sources at high frequencies, where the coupling effect severely degrades the quality at the edges of the field of view. Therefore, mitigating this coupling effect remains a critical challenge for radio interferometric arrays in astronomical imaging. Additionally, the vast amount of data generated per observation makes data processing a primary bottleneck hindering rapid radio observation. In the era of big data, the demand for parallel processing of even larger datasets has grown, yet traditional data processing techniques in radio astronomy can no longer meet these demands. Given its capability for rapidly extracting key information from large datasets, deep learning is poised to play a significant role in astronomical data processing and represents an important future trend for the development of radio astronomy.

Among the existing algorithms for eliminating the coupling effect between the main beam and the synthesized beam, the most widely used is the traditional image-domain main beam correction method. However, this method is only suitable for effect removal in high Signal-to-Noise Ratio (SNR) images and performs poorly in eliminating the coupling effect at high frequencies. Thus, it is difficult for this method to achieve good performance in eliminating the coupling effect between the main beam and the synthesized beam in radio interferometric arrays. To address the challenge in existing technologies, it is necessary to provide a method for eliminating a coupling effect between a main beam and a synthesized beam in a radio interferometric array.

### SUMMARY

One or more embodiments of the present disclosure provide a method for eliminating a coupling effect between a main beam and a synthesized beam in a radio interferometric array. The method includes: constructing a residual processing module RpDH-Deeplab to process an input image containing effects and obtaining information Fₒᵤₜ of the input image; constructing an encoder within a segmentation network, wherein the encoder is configured to perform multi-level feature extraction on the input image through a backbone network MobileNet v2, and perform further feature extraction for a highest-level feature by using a DH-ASPP module to obtain DH-ASPPₒᵤₜ output from the DH-ASPP module; constructing a decoder within the segmentation network, to fuse low-level features output from the encoder with the high-level feature DH-ASPP . . . to obtain Decoderₒᵤₜ output from the decoder; and combining the Fₒᵤₜ with the Decoderₒᵤₜ and using an activation function Tanh to obtain an output of a RpDH-Deeplab network, wherein parameters of the RpDH-Deeplab network are updated through a plurality of rounds of training, to correct a main beam effect and a synthesized beam effect based on the output of the RpDH-Deeplab network.

### BRIEF DESCRIPTION OF THE DRAWINGS

FIG. 1 is a flowchart of an exemplary process for eliminating a coupling effect between a main beam and a synthesized beam in a radio interferometric array according to some embodiments of the present disclosure.

FIG. 2 is a flowchart of another exemplary process for eliminating a coupling effect between a main beam and a synthesized beam in a radio interferometric array according to some embodiments of the present disclosure.

FIG. 3 is a schematic diagram illustrating a residual processing module according to some embodiments of the present disclosure.

FIG. 4 is a schematic diagram illustrating an RpDH-Deeplab network framework according to some embodiments of the present disclosure.

FIG. 5 is a schematic diagram illustrating a structure of an encoder according to some embodiments of the present disclosure.

FIG. 6 is a schematic diagram illustrating a structure of a DH-ASPP network according to some embodiments of the present disclosure.

FIG. 7 is a schematic diagram illustrating a structure of a decoder according to some embodiments of the present disclosure.

### DETAILED DESCRIPTION

In the following detailed description, numerous specific details are set forth by way of examples to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and are not intended to limit the scope of the present disclosure. Unless obviously obtained from the context or the context illustrates otherwise, the same numeral in the drawings refers to the same structure or operation.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” as used in the claims and the specification includes any and all combinations of one or more of the associated listed items. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

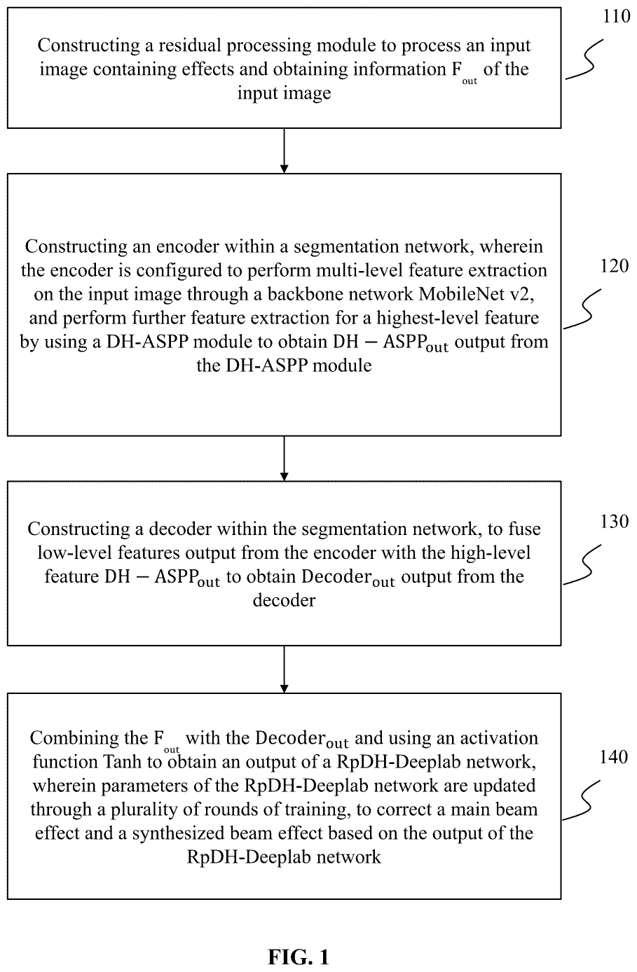

FIG. 1 is a flowchart of an exemplary process for eliminating a coupling effect between a main beam and a synthesized beam in a radio interferometric array according to some embodiments of the present disclosure. A method for eliminating a coupling effect between a main beam and a synthesized beam in a radio interferometric array, provided according to some embodiments of the present disclosure, may be executed by a processor. The method may include the following operations 110 to 140.

In 110, constructing a residual processing module to process an input image containing effects and obtaining information Fₒᵤₜ of the input image.

The residual processing module refers to a functional component at a front end of a DH-Deeplab neural network model.

The residual processing module is denoted as RpDH-Deeplab, with an input feature Fᵢₙ and an output Fₒᵤₜ. The RpDH-Deeplab is configured to perform feature extraction and information retention on the input image containing the coupling effect between the main beam and the synthesized beam, for subsequent correction by a subsequent network.

In some embodiments of the present disclosure, “RpDH-Deeplab” may also be referred to as an RpDH-Deeplab network, an RpDH-Deeplab network structure, an RpDH-Deeplab model, or the like.

In some embodiments, the output Fₒᵤₜ of the attention module and the input image information Fₒᵤₜ belong to a same data stream.

In some embodiments, the residual processing module includes two 3×3 convolutional layers, two feature extraction attention blocks (EABs) and a residual connection. Each feature extraction attention block includes a feature extraction module and an attention module. The feature extraction module employs 3×3 convolution for preliminary feature extraction on the information of the input image (also referred to as the input image information), and the input image information is preserved via the residual connection. The attention module includes a spatial attention module, a channel attention module, and a global average pooling module.

The 3×3 convolutional layer is configured to perform preliminary feature extraction on the input image information.

Each convolutional layer employs a stride of 1 and appropriate zero-padding to maintain a feature map size unchanged. Each convolutional layer may be followed by a Batch Normalization (BN) layer and a nonlinear activation function (e.g., ReLU) to enhance feature representation capability and stabilize training. The residual connection establishes a direct path between the input and the output of the module, performing an element-wise addition between the identity-mapped input feature Fᵢₙ and features processed by convolution and EAB operations. This facilitates the extraction of coupling-effect-related features while preserving the original image information, thereby preventing feature degradation and gradient vanishing.

The feature extraction module uses 3×3 convolution to perform the preliminary feature extraction on the input image information, aiming to acquire basic features within the input image.

Each feature extraction attention block (EAB) includes a feature extraction module and an attention module. The feature extraction module employs 3×3 convolution to perform preliminary feature extraction on the input feature, obtaining intermediate features to capture local spatial correlations and refine information from salient regions. Simultaneously, the residual connection preserves global information from the input image, ensuring that an overall brightness and a contour structure of the input image are maintained even during deep feature extraction.

The residual connection within the module preserves the original information of the input image, effectively avoiding the loss of critical information during the preliminary processing stage and ensuring the integrity of the information flow.

The attention module is configured to weight and optimize the preliminarily extracted feature. The attention module comprises a spatial attention (SA) module, a channel attention (CA) module, and a global average pooling (GAP) module. The spatial attention module and the channel attention module are configured to weight and refine the feature information from a spatial dimension and a channel dimension, respectively.

The attention module is configured to perform weighting enhancement on key information at a feature level, and consists of the spatial attention module, the channel attention module, and the global average pooling module. The channel attention module models response strengths of different feature channels. The channel attention module may obtain a statistical feature vector for each channel through a global average pooling operation, and generate channel weights via a series of fully connected layers and activation functions, thereby emphasizing or suppressing specific channels. The spatial attention module calculates a distribution of feature responses across spatial dimensions to generate a spatial weight map, assigning higher attention to salient regions.

The global average pooling (GAP) module performs global averaging over the spatial dimensions, integrating overall distribution information of the intermediate features into a global descriptor, which assists the channel attention module in generating more representative weights. The channel attention module and the spatial attention module are fused via broadcasting and element-wise multiplication operations to obtain hybrid attention, which subsequently undergoes global average pooling along the channel dimension to generate a channel calibration vector.

In some embodiments, the processing steps for the input feature Fᵢₙ (derived from the output of the feature extraction module) includes: applying a spatial attention mechanism, a channel attention mechanism, and a hybrid attention mechanism to the input feature Fᵢₙ respectively to obtain Fₛ, F_{c}, and F_{cs}; performing a global average pooling operation on the F_{cs} to obtain Fₚ; multiplying the Fₚ with the F_{c} and the Fₛ respectively to obtain F_{cp} and Fₛₚ; multiplying the Fₛₚ with the Fᵢₙ, and then multiplying a result of the multiplication between the Fₛₚ and the Fᵢₙ with the F_{cp} to obtain the Fₒᵤₜ of the attention module, as shown in the following formula:

$${F}_{out} = {{F}_{sp}}^{*} {{F}_{in}}^{*} {F}_{cp} = {{F}_{s}}^{*} {{F}_{p}}^{*} {{F}_{in}}^{*} {{F}_{c}}^{*} {F}_{p} .$$

The hybrid attention mechanism is a weighting mechanism configured to extract important information simultaneously or in combination across both spatial and channel dimensions. Its purpose is to integrate with the results of other single attention mechanisms to more comprehensively screen feature information.

Employing the attention module can significantly enhance sensitivity of the RpDH-Deeplab network to artifacts arising from the coupling between the main beam and the synthesized beam. Through a stepwise strategy of first performing spatial weighting followed by channel calibration, this approach facilitates the suppression of local artifacts and the highlighting of genuine astronomical structures while preserving image brightness and morphological information, thereby improving the accuracy and robustness of coupling effect correction in subsequent segmentation or regression tasks.

In some embodiments, parameters and structures of the various modules may be flexibly adjusted based on hardware performance and data resolution. For example, the kernel size of the convolutional layer may vary from 1×1 to 5×5, the stride may be set to 1 or 2; the activation function may be ReLU, Leaky ReLU, or Swish, the channel compression ratio of a fully connected layer may be any integer between 8 and 32. The channel attention module and the spatial attention module may also adopt other equivalent structures, such as a SE (Squeeze-and-Excitation) module or a CBAM (Convolutional Block Attention Module). These alternative forms are functionally equivalent to the modules described in the present disclosure, as they all achieve importance weighting of feature channels and spatial dimensions, and belong to equivalent alternative schemes of some embodiments of the present disclosure.

The feature extraction attention block achieves repeated extraction of important information from the spatial and channel dimensions of the input image, ensuring that the information input to the main network is optimized and more targeted features. This structured residual module can provide more effective original image information for coupling effect correction, thereby enabling an RpDH-Deeplab network to achieve efficient and precise coupling effect correction.

An input image containing effects refers to an image that includes the coupling effect between the main beam and the synthesized beam.

In some embodiments, the processor observes and records interferometric data via a radio interferometric array, performs calibration and scaling processing on the interferometric data to eliminate influences caused by the atmosphere and instruments, and uses an inverse Fourier transform to convert the calibrated interferometric data into an image of a sky brightness distribution. The final obtained image, although having undergone deconvolution processing, still retains the coupling effect between the main beam and the synthesized beam. This image serves as the input image.

The information Fₒᵤₜ of the input image is the enhanced feature information obtained after the residual processing module (RpDH-Deeplab) processes the input image containing effects.

In 120, constructing an encoder within a segmentation network, wherein the encoder is configured to perform multi-level feature extraction on the input image through a backbone network MobileNet v2, and perform further feature extraction for a highest-level feature by using a DH-ASPP module to obtain DH-ASPPₒᵤₜ output from the DH-ASPP module.

The multi-level feature extraction refers to a process in which the MobileNet v2 backbone network, through convolutional and downsampling operations at different depths of the segmentation network, extracts feature maps possessing different resolutions (scales) and semantic information. Examples include low-level features, high-level features, and a highest-level feature. Further relevant description may be found in the corresponding sections below.

In some embodiments, the processor constructs the encoder structure within the segmentation network. The segmentation network is improved based on Deeplab v3+, which facilitates better feature extraction and enables more effective extraction of astronomical structures from the input image affected by the main beam effect. The encoder performs gradual convolution and pooling operations on the input image containing effects, extracting semantic features at different levels.

In some embodiments of the present disclosure, “DH-ASPP” may be referred to as the DH-ASPP module, a DH-ASPP network, a DH-ASPP structure, a DH-ASPP model, or the like.

More descriptions regarding the construction of the DH-ASPP network within the RpDH-Deeplab network may be found later in the present disclosure.

In 130, constructing a decoder within the segmentation network, to fuse low-level features output from the encoder with the high-level feature DH-ASPPₒᵤₜ to obtain Decoderₒᵤₜ output from the decoder.

The decoder refers to a module within the segmentation network responsible for bottom-up reconstruction of a high-resolution output. Inputs of the decoder include low-level features (e.g., F₈, F₄, F₂) generated by the encoder at multiple downsampling scales and the high-level feature (DH-ASPPₒᵤₜ) enhanced by the DH-ASPP module from a topmost layer of the encoder. The output of the decoder is denoted as Decoderₒᵤₜ. A spatial resolution of the output of the decoder preferably matches that of the original input image lin, and a count of channels of the output of the decoder depends on a subsequent task (e.g., single-channel regression or a count of channels for multi-class segmentation).

In some embodiments, the processor first upsamples DH-ASPPₒᵤₜ to the spatial resolution of the closest low-level feature (e.g., F₈,). Subsequently, the upsampled DH-ASPPₒᵤₜ is concatenated (Cat) with the low-level feature along the channel dimension. A concatenated result undergoes processing by a series of convolutional units to fuse channel and spatial information and refine edge structures. A fused result is then upsampled to a next resolution and the aforementioned concatenation and convolution operations are repeated with a next low-level feature (e.g., F₄,). This process is repeated sequentially until fusion with the feature at the smallest downsampling factor (e.g., F₂) is achieved. Finally, channel integration (e.g., via 1×1 convolution) is performed on the final fused feature, followed by upsampling (if needed) to the input resolution, to obtain the Decoderₒᵤₜ. The aforementioned upsampling may employ the same or different techniques at each layer, as needed, to align spatial dimensions.

The upsampling may employ any one of bilinear interpolation, nearest-neighbor interpolation, transposed convolution (deconvolution), pixel shuffle, or a combination thereof.

The concatenation (Cat) operation is performed along the channel dimension by default. After concatenation, 3×3 convolutional units are preferentially used for feature integration. In some embodiments, 1 to 3 consecutive 3×3 convolutional units are used after each concatenation to achieve thorough fusion.

In some embodiments, the kernel size of the convolutional layers used for concatenation and fusion may vary within a range from 1×1 to 5×5. To achieve a more lightweight design, the count of convolutional units per stage may be reduced, or standard convolution may be replaced with depthwise separable convolutions. To achieve stronger contextual modeling, dilated convolutions or attention modules may be incorporated after fusion. The order of upsampling and fusion (convolution before upsampling or upsampling before convolution) at various stages may be freely interchanged, all of which falling within the scope of equivalent implementations protected by some embodiments of the present disclosure.

A low-level feature refers to a feature map produced by the encoder when the downsampling factor is relatively small (e.g., 2, 4, or 8), which retains more spatial details and edge information, denoted as F₂, F₄, and F₈, etc., where the subscript indicates the spatial downsampling factor relative to the input image.

A high-level feature refers to a semantic-rich, context-abundant feature with a relatively low spatial resolution, formed at the topmost layer of the encoder or after processing by an enhancement module (e.g., the DH-ASPP module).

The relatively low spatial resolution means the feature map has a smaller dimension (i.e., width and height) in the spatial domain compared to the input image and the low-level features.

In some embodiments, the highest-level feature is denoted as F₁₆ or DH-ASPPₒᵤₜ after being enhanced by the DH-ASPP module.

In some embodiments, for any given scale s (taking F₈ as an example), the processor performs the following operations in sequence: first, the processor upsamples the high-level feature DH-ASPPₒᵤₜ to the same spatial resolution as the low-level feature F₈, with the upsampled result denoted as U(DH-ASPPₒᵤₜ). To prevent channel mismatch, U(DH-ASPPₒᵤₜ) and F₈ are each processed with a 1×1 convolution for channel alignment or dimensionality reduction (e.g., reducing the count of channels for both the U(DH-ASPPₒᵤₜ) and F₈ to C′). The results are then concatenated (Cat) along the channel dimension. After concatenation, the concatenated result is processed by a plurality of 3×3 convolutional units (each followed by BN and an activation function such as ReLU) to achieve deep fusion and edge refinement. The resulting fused feature then serves as the input for upsampling and fusion with the low-level feature at the next scale. The above process is iterated until the shallowest scale is reached.

In some embodiments, when the channel counts match, the processor may use element-wise addition as a lightweight alternative. Attention weighting (e.g., channel attention, spatial attention, or self-attention) may be added after concatenation to adaptively adjust the importance of features from different scales. The aforementioned alternatives do not alter the essence of the fusion and fall within the scope of implementations protected by some embodiments of the present disclosure.

In 140, combining the Fₒᵤₜ with the Decoderₒᵤₜ and using an activation function Tanh to obtain an output of the RpDH-Deeplab network, wherein parameters of the RpDH-Deeplab network are updated through a plurality of rounds of training, to correct the main beam effect and the synthesized beam effect based on the output of the RpDH-Deeplab network.

In some embodiments, the processor trains the RpDH-Deeplab network based on training samples and corresponding labels.

In some embodiments, the training samples include radio astronomical images containing the coupling effect between the main beam and the synthesized beam. The processor acquires the training samples based on observational data from a radio interferometric array.

In some embodiments, the labels comprise corrected target images corresponding to the training samples that are free from the coupling effect between the main beam and the synthesized beam, or correction maps/masks for precisely eliminating the coupling effect. The processor acquires the labels by accessing system-stored data.

In some embodiments, the processor, through multiple rounds of training, updates the parameters of the RpDH-Deeplab network so that the output of the RpDH-Deeplab network closely approximates an ideal corrected target image, thereby achieving precise correction of the coupling effect.

In some embodiments, the segmentation network is improved based on a Deeplab v3+ network. In the RpDH-Deeplab network, the MobileNet v2 is used as the backbone network for the segmentation network. The MobileNet v2 employs an inverted residual block. The MobileNet v2 is configured with four convolutional operations having a stride of 2. Contextual information of the input image is extracted via spatial pyramid pooling (SPP), and a dilated convolution operation is added to the SPP in the Deeplab v3+ network. A hybrid dilated convolution (HDC) is incorporated into the RpDH-Deeplab network to extract features at different scales based on different dilation rates, and a dense connection operation is incorporated. A DH-ASPP network structure within the RpDH-Deeplab network is constructed by incorporating the dense connection and the HDC, based on an Atrous Spatial Pyramid Pooling (ASPP) module and characteristics of a radio astronomical structure.

The Deeplab v3+ network is a known semantic segmentation network based on an encoder-decoder structure, which incorporates an ASPP module at the top of its encoder to extract multi-scale contextual information.

The SPP (Spatial Pyramid Pooling) refers to a multi-scale spatial pyramid pooling structure.

The dilated convolution is a form of convolution that expands the receptive field by inserting holes (zeros) within the convolutional kernel.

The hybrid dilated convolution (HDC) refers to the use of convolutional operations with multiple different dilation rates, in parallel or in series within the same module, to achieve multi-scale feature extraction.

The dense connection refers to a connection manner where feature outputs from different layers or branches are directly connected to achieve information reuse and gradient enhancement.

In some embodiments, the MobileNet v2 is formed by stacking a plurality of inverted residual blocks. Each inverted residual block is configured to: first perform a 1×1 convolution operation for dimension expansion; then perform a 3×3 depthwise separable convolution; and finally perform a 1×1 convolution for dimension reduction.

The inverted residual block refers to a structure that first expands the count of input channels to a larger count of intermediate channels (dimension expansion), performs spatial convolution (typically depthwise separable convolution) on the expanded channels, and finally projects the count of the channels back to a target output channel count (dimension reduction).

A depthwise separable convolution consists of a depthwise convolution (performing spatial convolution independently on each channel) and a pointwise 1×1 convolution (performing linear combination across channels).

The inverted residual block first performs the 1×1 convolution operation to expand the dimensionality of the feature map along the channel dimension (dimension expansion), ensuring information is fully utilized before processing in a lower-dimensional space. Next, the 3×3 depthwise separable convolution is performed: the 3×3 depthwise separable convolution is subsequently applied for feature processing. The depthwise separable convolution decomposes a standard convolution into the depthwise convolution (performed independently on each channel) and the pointwise convolution (1×1 convolution for channel combination), reducing computational cost and parameter count. Finally, dimension reduction is achieved via the 1×1 convolution: the 1×1 convolution operation is used to reduce the channel dimensionality of the feature map (dimension reduction), restoring the channel count of the feature map to approximately the count of channels of the input image.

In practical applications of the MobileNet v2, an expansion factor (i.e., the count of repeated structures within the inverted residual block) and channels (reflecting the change in the count of feature channels before and after each operation) are set in the inverted residual block, where the stride is applied only to the first layer of each repeated structure.

In some embodiments of the present disclosure, the inverted residual block employs a design that expands dimensions in an intermediate layer, applies lightweight spatial convolution, and then reduces dimensions. This design not only provides sufficient non-linearity and representational capacity to capture complex features but also significantly reduces the count of parameters and computational load, which can improve training stability and convergence speed. Stacking multiple inverted residual units to form the MobileNet v2 provides the RpDH-Deeplab network with a lightweight, efficient, and multi-scale feature extraction capability, making the RpDH-Deeplab network suitable for resource-constrained or real-time processing scenarios and facilitates the subsequent multi-scale fusion in the DH-ASPP module and the decoder, as well as the accurate execution of the coupling effect correction task.

In some embodiments, four changes in a feature size of the MobileNet v2 are 184×184, 92×92, 46×46, and 23×23, corresponding respectively to four features at the different scales: F₂, F₄, F₈, and F₁₆. The F₁₆ is the highest-level feature. In the RpDH-Deeplab network, the F₁₆ is input to the DH-ASPP module for further feature extraction; and the F₂, the F₄, and the F₈ are input to the decoder for feature fusion.

As the backbone network of the encoder, the MobileNet v2 achieves downsampling of the input image by employing four convolutional operations with a stride of 2, resulting in a total of four changes in the feature size. These four changes in the feature size are 184×184, 92×92, 46×46, and 23×23, corresponding respectively to four features at different scales: F₂, F₄, F₈, and F₁₆. The subscript X in Fₓ represents the downsampling factor of the size of the feature map relative to the size of the original input image.

Among the four features at different scales, F₁₆ is the highest-level feature. This feature possesses the lowest spatial resolution but contains the most abstract and richest semantic information. In the RpDH-Deeplab network, the F₁₆ is input to the DH-ASPP module for further feature extraction. The DH-ASPP module utilizes the hybrid dilated convolution and the dense connection to finely capture and enhance the contextual information of F₁₆, ultimately outputting DH-ASPPₒᵤₜ.

In contrast, F₂, F₄, and F₈ are low-level features. These features have relatively high spatial resolution and contain rich spatial detail information from the image, such as edges and textures in the image. In the RpDH-Deeplab network, F₂, F₄, and F₈ are input to the decoder for feature fusion with the upsampled high-level feature DH-ASPPₒᵤₜ. This feature fusion ensures that the model output possesses both accurate semantic information and clear spatial details, enabling pixel-level precise correction.

By specifying the backbone network MobileNet v2 and its core inverted residual block, the implementation details of the encoder are further clarified. The inverted residual block offers significant advantages in deep learning: it ensures model lightweight and high efficiency while avoiding information loss in lower dimensions through its sequence of dimension expansion followed by reduction. This guarantees that the RpDH-Deeplab network can extract high-quality image features for coupling effect correction at a minimal computational cost.

In some embodiments, the MobileNet v2 may be replaced with other lightweight backbone networks, such as MobileNet v3, EfficientNet-lite, or ShuffleNet. Furthermore, the expansion/reduction ratio of the inverted residual block may be adjusted based on hardware conditions (typically within a range of 4-8 times). The kernel size of the dilated convolution may be 3×3 or 5×5, and the dilation rate may be selected from a range of 1 to 12 depending on the input size and scale characteristics of coupling features. The branch count of the hybrid dilated convolution module may be increased or decreased, and dense connections may be established between all branches or only a subset of branches. For smaller networks or real-time tasks, a lightweight DH-ASPP may be used, retaining only two layers of dilated convolutions and a simplified dense connection structure. The aforementioned variants, without altering the principles of multi-scale feature extraction and dense connections, all fall within the scope of equivalent implementations of some embodiments of the present disclosure.

Some embodiments of the present disclosure, by introducing the MobileNet v2 backbone, the hybrid dilated convolution, and the dense connection based on the Deeplab v3+ framework, significantly enhance feature representation capability while maintaining network lightweight and high efficiency. The inverted residual design of the MobileNet v2 reduces computational complexity and improves feature extraction efficiency. The four convolutional operations with a stride of 2 form a multi-scale hierarchical structure, aiding in capturing beam features at different scales in radio images. The hybrid dilation and dense connection design of the DH-ASPP module effectively mitigates the gridding issue associated with traditional dilated convolutions and enhances multi-scale feature fusion capability. The RpDH-Deeplab network demonstrates significant advantages in suppressing artifacts arising from the coupling effect between the main beam and the synthesized beam, improving the recognition accuracy of small-scale structures, and preserving details in radio images. The RpDH-Deeplab network enables efficient, stable, and scalable automatic correction of the coupling effect in radio interferometric array imaging.

In some embodiments, the DH-ASPP module includes four hybrid dilated convolutions: Part-1, Part-2, Part-3, and Part-4. Each hybrid dilated convolution consists of three dilated convolution modules, each of the three dilated convolution modules includes a convolutional layer, a batch normalization layer, and an activation function. The dilated convolution modules are configured with different dilation rates to interrelate dilated convolution results.

The densely-connected hybrid dilated convolution atrous spatial pyramid pooling (DH-ASPP) module is a core module within the RpDH-Deeplab network for performing further extraction on the highest-level feature. The main body of the DH-ASPP module consists of the four hybrid dilated convolutions (Part-1, Part-2, Part-3, and Part-4) and an encoder-decoder module (Part-5). Part-1 to Part-4 are the four hybrid dilated convolutions.

Each of the four hybrid dilated convolutions is composed of three dilated convolution modules (e.g., Conv_{L}_{₁}, Conv_{L}_{₂}, and Conv_{L}_{₃}). A dilated convolution module is a basic unit that performs the convolution operation. Each module includes a convolutional layer, a batch normalization layer, and an activation function (e.g., ReLU). These layers collectively ensure the non-linearity and stability of feature extraction.

The dilated convolution modules are configured to have different dilation rates. For example, the three dilated convolution modules within a hybrid dilated convolution may have different dilation rates of i₁, i₂, and i₃. In some embodiments, the three different dilation rates i₁, i₂, and i₃ corresponding to different hybrid dilated convolutions may each be configured with different values.

Configuring different dilation rates addresses the issue in standard dilated convolution where results of standard dilated convolutions become uncorrelated due to skipped pixels. The configuration of different dilation rates interconnects the results of the dilated convolutions while covering multiple different scales, thereby effectively capturing multi-scale information and achieving the goal of precise feature extraction for small-scale astronomical structures in radio images.

By defining the precise count and internal structure of the hybrid dilated convolutions within the DH-ASPP module, the protection of the core innovation point, DH-ASPP, is further strengthened, thereby significantly enhancing the network's capability to extract complex multi-scale features and serves as the technical guarantee for achieving high-precision coupling effect correction.

In some embodiments, the Part-5 includes a pooling operation, a convolution operation, and an upsampling operation, constructing a Encoder-Decoder module (E-D) for a final feature extraction, represented by the following formula:

$$DH - {ASPP}_{out} = Cat \{ {Conv}_{{L}_{1}} , {Conv}_{{L}_{2}} , {Conv}_{{L}_{3}} , {Conv}_{{L}_{4}} , E - D \} ,$$

$${Conv}_{{L}_{n}} = {Conv}_{{R}_{i 3}} ( {Conv}_{{R}_{i 2}} ( {Conv}_{{R}_{i 1}} ) ) ,$$

where Cat denotes a concatenation operation, Conv denotes a convolution operation, Conv_{L}_{ₙ} denotes an output feature map corresponding to a combination of the three dilated convolution modules within an n-th hybrid dilated convolution, Conv_{L}_{₁}, Conv_{L}_{₂}, Conv_{L}_{ₐ}, and Conv_{L}_{₄} denote output feature maps of the four hybrid dilated convolutions the Part-1, the Part-2, the Part-3, and the Part-4 in the DH-ASPP module, respectively, i₁, i₂, and i₃ denote three different dilation rates for each hybrid dilated convolution, and Conv_{R}_{ᵢ₁}, Conv_{Ri}_{₂}, and ConV_{R}_{ᵢ₃} denote dilated convolution modules with the dilation rates i₁, i₂, and i₃, respectively.

The concatenation operation (Cat) refers to stacking and merging two or more feature maps with identical spatial dimensions (i.e., the same height and width) along the channel dimension, thereby forming a new feature map with a greater channel count.

The convolution operation (Conv) is a fundamental and core computation in Convolutional Neural Networks (CNNs). It employs a learnable convolutional kernel (or filter) to perform a weighted summation over local regions of an input feature map, thereby extracting features and generating an output feature map.

The dilation rate is denoted as d, which is used to specify a spacing inserted between elements of the convolutional kernel in a dilated convolution.

In some embodiments of the present disclosure, the dilation rate is also referred to as an atrous rate. Dilated convolution expands the receptive field by introducing intervals between the elements of a standard convolutional kernel, without increasing the count of parameters or altering the input and output resolution.

In some embodiments of the present disclosure, by channel-wise concatenation of the results from the four HDC parts with different dilation rate combinations and the E-D module containing global information, this structure ensures that DH-ASPPₒᵤₜ can simultaneously capture multi-scale contextual information at local, medium, and global scales, thereby enhancing the RpDH-Deeplab network's feature representation capability and robustness for complex radio astronomical structures and the coupling effect.

In some embodiments, the decoder of the RpDH-Deeplab network is configured to capture contextual information at a same resolution as the input image for pixel-level segmentation. The decoder is configured to fuse the low-level features output from the encoder with the high-level feature, the fusion process being represented as:

$${Decoder}_{out} = {U}_{N} ( Cat ( {F}_{2} , {U}_{2} ( Cat ( {F}_{4} , {U}_{4} ( Cat ( {F}_{8} , {U}_{8} ( {Encoder}_{out} ) ) ) ) ) ) ) ,$$

where Decoderₒᵤₜ denotes a final output of the decoder, F₂, F₄, and F₈ denote feature maps produced by the encoder at spatial downsampling factors of 2, 4, and 8 relative to the input image, respectively, U_{N}, U₂, U₄, and U₈ denote upsampling operations by factors of N, 2, 4, and 8, respectively, Cat denotes a concatenation operation, and Encoderₒᵤₜ denotes an output of the encoder.

The decoder of the RpDH-Deeplab network is configured to fuse multi-level feature information extracted by the encoder and restore resolution. The decoder is configured to the contextual information at the same resolution as the input image, thereby achieving fine pixel-level segmentation (or correction) of the image affected by the coupling effect. The decoder is a key component for achieving precise pixel-level correction and restoring image details.

The decoder is configured to perform multi-level feature fusion of the low-level features output from the encoder (e.g., F₂, F₄, and F₈, which contain edge and detail information of the input image) with the high-level feature DH-ASPPₒᵤₜ (i.e., the output Encoderₒᵤₜ of the encoder), which is rich in semantic information and global contextual information). The feature fusion process involves progressively restoring the resolution and concatenating the features. The multi-feature fusion strategy ensures that more contextual information is input into the neural network, thereby guaranteeing better correction of the coupling effect.

By defining the functional configuration of the decoder and the feature fusion formula, the semantic recognition capability of high-level features and the spatial detail capability of low-level features are effectively combined. This approach ensures that during pixel-level correction, astronomical structures can be accurately identified while maintaining clear boundaries and details, thereby significantly enhancing the correction accuracy and refinement for the coupling effect between the main beam and the synthesized beam.

The embodiments of the present disclosure are further described in detail below in conjunction with the accompanying drawings and implementation process.

In some embodiments, the implementation process is as follows.

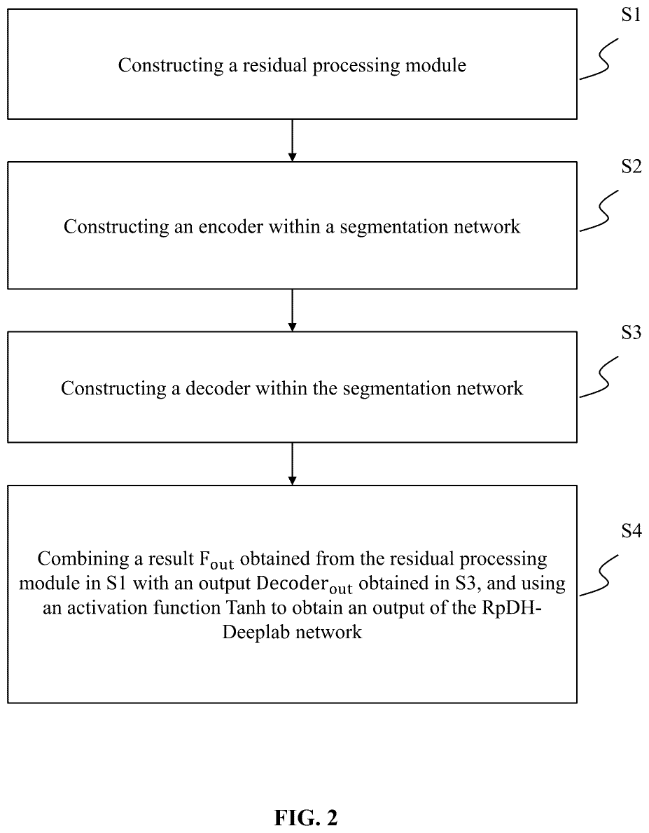

FIG. 2 is a flowchart of another exemplary process for eliminating a coupling effect between a main beam and a synthesized beam in a radio interferometric array according to some embodiments of the present disclosure.

As shown in FIG. 2, the method for eliminating the coupling effect between the main beam and the synthesized beam in a radio interferometric array, provided according to some embodiments of the present disclosure, may be executed by a processor. The method may include the following operations S1 to S4.

In S1, constructing a residual processing module RpDH-Deeplab.

In some embodiments, the processor processes an input image containing effects, thereby providing the most comprehensive and effective information Fₒᵤₜ of the input image for the subsequent network, which contributes to more effectively correcting the main beam effect.

In S2, constructing an encoder within a segmentation network.

In some embodiments, the encoder is configured to perform multi-level feature extraction on the input image through a backbone network MobileNet v2, and perform further feature extraction for a highest-level feature by using a DH-ASPP module. A dense connection and a hybrid dilated convolution are used to reduce computational parameters of the DH-ASPP model, thereby significantly decreasing the computational load, preventing overfitting, and enhancing generalization capability of the RpDH-Deeplab model. Finally, an output, denoted as DH-ASPPₒᵤₜ, from the DH-ASPP module is obtained.

In S3, constructing a decoder within the segmentation network.

In some embodiments, the decoder is configured to fuse tlow-level features output from the encoder with the high-level feature DH-ASPPₒᵤₜ. The fusion of a plurality of features ensures that a greater amount of contextual information is input into a neural network (e.g., the RpDH-Deeplab network), thereby guaranteeing improved correction of the coupling effect, and ultimately obtaining an output Decoderₒᵤₜ of the decoder.

In S4, combining the result Fₒᵤₜ obtained from the residual processing module in S1 with the output Decoderₒᵤₜ obtained in S3, and using an activation function Tanh to obtain an output of the RpDH-Deeplab network.

In some embodiments, the processor, through multiple rounds of training, updates parameters within the network structure such that the output of the RpDH-Deeplab network achieves precise correction of the main beam effect and the synthesized beam effect.

Considering that deep learning models need to extract contour and structural features, a neural network model of an image segmentation type, which is more sensitive to contours, may be selected. Furthermore, since the input of astronomical brightness information from images containing the coupling effect may be achieved using a residual connection from ResNet, it is determined that the main architecture of the deep learning model is an image segmentation network incorporating the residual connection.

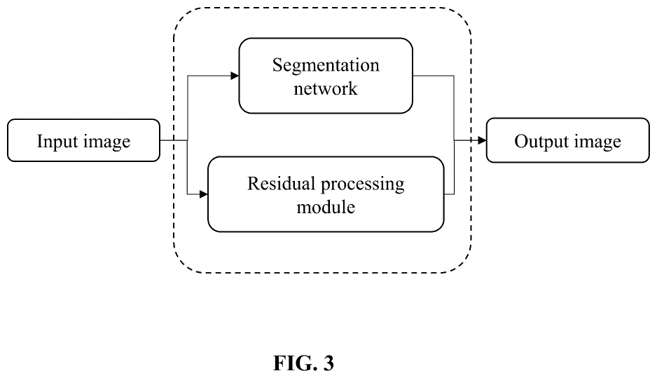

Based on the impact of the coupling effect on image formation, some embodiments of the present disclosure propose an RpDH-Deeplab network to achieve correction of the coupling effect. The overall framework of the RpDH-Deeplab network comprises a residual processing module and a segmentation network module, as shown in the schematic diagram of the residual processing module in FIG. 3.

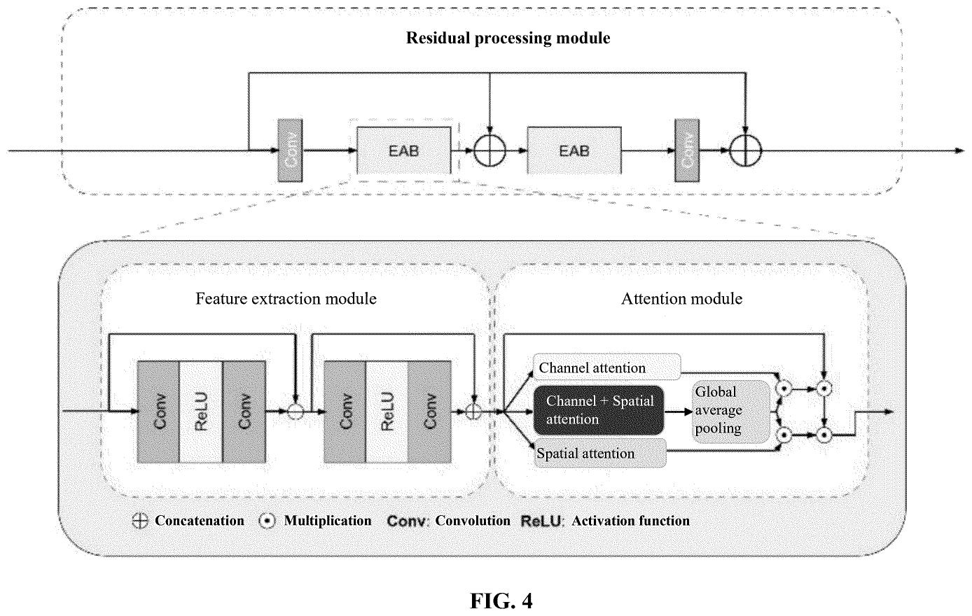

The residual processing module feeds more effective information from the input image into the segmentation network. The output provides more effective original image information for coupling effect correction, enabling the RpDH-Deeplab network to achieve more efficient and precise coupling effect correction. The framework of the RpDH-Deeplab network is shown in FIG. 4.

The residual processing module in S1 includes two 3×3 convolutional layers, two feature extraction attention blocks (EABs) and a residual connection. Each feature extraction attention block includes a feature extraction module and an attention module.

In some embodiments, the feature extraction module employs 3×3 convolution for preliminary feature extraction of the input image information, and the input image information is preserved via the residual connection.

In some embodiments, the attention module includes a spatial attention module, a channel attention module, and a global average pooling module. In some embodiments, the processing steps for the input feature Fᵢₙ (derived from the output of the feature extraction module) includes: applying a spatial attention mechanism, a channel attention mechanism, and a hybrid attention mechanism to the input feature Fᵢₙ respectively to obtain Fₛ, F_{c}, and F_{cs}; performing a global average pooling operation on the F_{cs} to obtain Fₚ; multiplying the Fₚ with the F_{c} and the Fₛ respectively to obtain F_{cp} and Fₛₚ; multiplying the Fₛₚ with the Fᵢₙ, and then multiplying a result of the multiplication between the Fₛₚ and the Fᵢₙ with the F_{cp} to obtain the Fₒᵤₜ of the attention module, as shown in the following formula:

$${F}_{out} = {{F}_{sp}}^{*} {{F}_{in}}^{*} {F}_{cp} = {{F}_{s}}^{*} {{F}_{p}}^{*} {{F}_{in}}^{*} {{F}_{c}}^{*} {F}_{p} .$$

The attention module achieves repeated extraction of important information from spatial and channel dimensions of the input image. Consequently, the entire residual processing module can provide the most comprehensive and effective information of the input image for the subsequent network, contributing to more effective correction of the main beam effect.

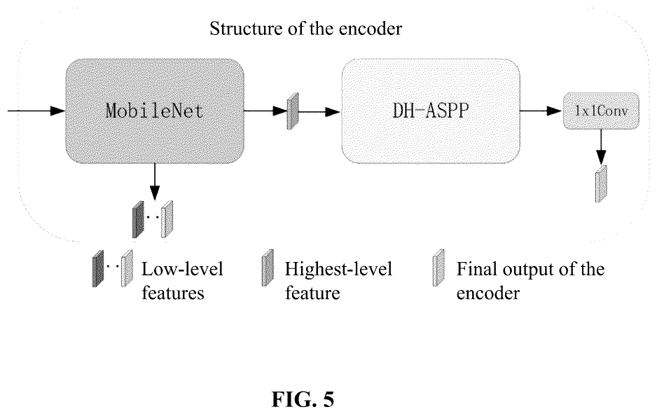

The segmentation network in S1 is improved based on a Deeplab v3+ network to enable more effective extraction of astronomical structures from the input image affected by the main beam effect. The segmentation network adopts an encoder-decoder architecture, which facilitates feature extraction. The encoder is shown in FIG. 5 is a block diagram of an exemplary structure of the encoder according to some embodiments of the present disclosure.

As shown in FIG. 5, the encoder primarily consists of the MobileNet v2 backbone network and the DH-ASPP module. The MobileNet v2 performs multi-level feature extraction on the input image, and its outputs include low-level features (e.g., F₂, F₄, and F₈) for the decoder and the highest-level feature (e.g., F₁₆). The highest-level feature is subsequently input to the DH-ASPP module for further feature extraction. The output of the DH-ASPP module, after being processed by a 1×1 convolution (1×1 Conv), obtains a final output (DH-ASPPₒᵤₜ) of the encoder.

Compared to the original Xception network in Deeplab v3+, the RpDH-Deeplab network adopts the MobileNet v2 as the backbone network for the segmentation network, which significantly reduces the count of parameters and increases the convergence speed of the RpDH-Deeplab network while maintaining performance, making the RpDH-Deeplab network more suitable for scenarios involving large volumes of data in radio astronomy.

The MobileNet v2 employs inverted residual blocks (Inverted Residuals). Compared to standard residual structures, the inverted residual block first performs a 1×1 convolution operation for dimension expansion, followed by a 3×3 depthwise separable convolution, and finally reduces dimensions via a 1×1 convolution. The MobileNet v2 is formed by stacking a plurality of inverted residual blocks. Here, the expansion factor refers to the count of repeated structures within the inverted residual block, channels refer to changes in the count of feature channels before and after each operation, and the stride is applied only to a first layer of each repeated structure.

The MobileNet v2 is configured with a total of four convolutional operations having a stride of 2, resulting in four changes in a feature size: 184×184, 92×92, 46×46, and 23×23, corresponding to four features at different scales: F₂, F₄, and F₈, and F₁₆. The F₁₆ is the highest-level feature. In RpDH-Deeplab, the F₁₆ is input to the DH-ASPP module for further feature extraction, while the F₂, the F₄, and the F₈ are input to the decoder for feature fusion.

The SPP may extract contextual information from the input image. Deeplab v3+ incorporates dilated convolution operations based on SPP. Dilated convolution increases the receptive field within the network and reduces computational load without sacrificing spatial resolution or input information, while also capturing more contextual information. It performs well for large-scale structures in detection and segmentation tasks. However, because dilated convolution computes in a checkerboard-like pattern, the results from the convolution operation at one layer all originate from independent sets of the previous layer, with no relationship between the results. This leads to uncorrelated convolution outputs and may cause local information loss. Given that radio astronomical observations contain numerous faint, small-scale astronomical structures, dilated convolution operations can prevent the effective extraction of features from these small-scale structures.

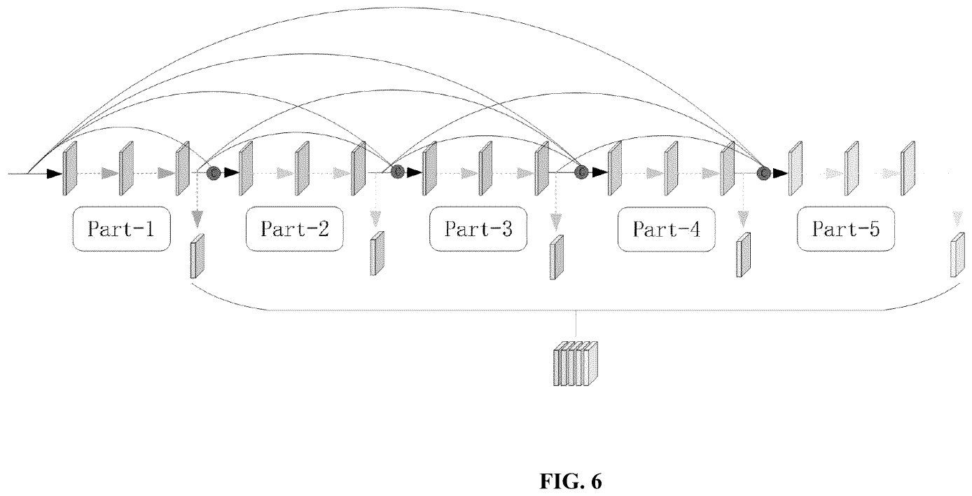

Therefore, a hybrid dilated convolution (HDC) is incorporated into the RpDH-Deeplab network, using different dilation rates to achieve feature extraction at different scales. This creates more interconnections between the convolution results and covers multiple different scales, achieving the goal of precise feature extraction for small-scale astronomical structures. Considering the increased structural complexity after adding the HDC, a dense connection is incorporated. Leveraging the advantages of the residual connection, the module with the added dense connection reduces the computational parameters of the model, thereby significantly decreasing the computational load, preventing overfitting, and enhancing the model's generalization capability. Based on the ASPP module and considering the characteristics of radio astronomical structures, the dense connection and the hybrid dilated convolution (HDC) are incorporated, ultimately constructing the DH-ASPP network structure within RpDH-Deeplab, as shown in FIG. 6.

FIG. 6 is a schematic diagram illustrating a structure of a DH-ASPP network according to some embodiments of the present disclosure. As shown in FIG. 6, the DH-ASPP module includes four hybrid dilated convolutions: Part-1, Part-2, Part-3, and Part-4. Each hybrid dilated convolution consists of three dilated convolution modules, each of the three dilated convolution modules includes a convolutional layer, a batch normalization layer, and an activation function. The dilated convolution modules are configured with different dilation rates to interrelate dilated convolution results.

In some embodiments, the Part-5 includes a pooling operation, a convolution operation, and an upsampling operation, constructing a Encoder-Decoder module (E-D) for a final feature extraction, represented by the following formula:

$$DH - {ASPP}_{out} = Cat \{ {Conv}_{{L}_{1}} , {Conv}_{{L}_{2}} , {Conv}_{{L}_{3}} , {Conv}_{{L}_{4}} , E - D \} ,$$

$${Conv}_{{L}_{n}} = {Conv}_{{R}_{i 3}} ( {Conv}_{{R}_{i 2}} ( {Conv}_{{R}_{i 1}} ) ) ,$$

where Cat denotes a concatenation operation, Conv denotes a convolution operation, Conv_{L}_{ₙ} denotes an output feature map corresponding to a combination of the three dilated convolution modules within an n-th hybrid dilated convolution, Conv_{L}_{₁}, Conv_{L}_{₂}, Conv_{L}_{₃}, and Conv_{L}_{₄}, denote output feature maps of the four hybrid dilated convolutions the Part-1, the Part-2, the Part-3, and the Part-4 in the DH-ASPP module, respectively, i₁, i₂, and i₃ denote three different dilation rates for each hybrid dilated convolution, and Conv_{R}_{ᵢ₁}, ConU_{R}_{ᵢ₂}, and Conv_{R}_{ᵢ₃} denote dilated convolution modules with the dilation rates i₁, i₂, and i₃, respectively.

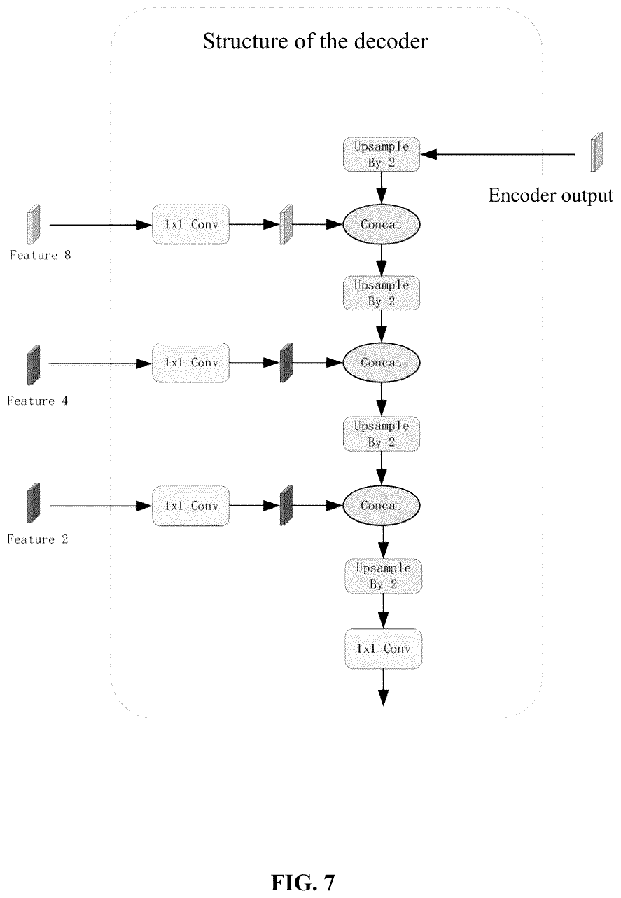

The decoder of the RpDH-Deeplab model described in S3 is configured to capture contextual information at a same resolution as the input image for pixel-level segmentation. A block diagram of the decoder network is shown in FIG. 7.

The decoder is configured to fuse the low-level features output from the encoder with the high-level feature, the fusion process being represented as:

$${Decoder}_{out} = {U}_{N} ( Cat ( {F}_{2} , {U}_{2} ( Cat ( {F}_{4} , {U}_{4} ( Cat ( {F}_{8} , {U}_{8} ( {Encoder}_{out} ) ) ) ) ) ) ) ,$$

where Decoderₒᵤₜ denotes the output of the decoder, F₂, F₄, and F₈ denote feature maps produced by the encoder at spatial downsampling factors of 2, 4, and 8 relative to the input image, respectively, U_{N}, U₂, U₄, and U₈ denote upsampling operations by factors of N, 2, 4, and 8, respectively, Cat denotes a concatenation operation, and Encoderₒᵤₜ denotes the output of the encoder.

As shown in the schematic diagram of the structure of the decoder in FIG. 7, the decoder receives low-level features (e.g., the F₂, the F₄, and the F₈) and the high-level feature (the output of the encoder, i.e., the DH-ASPPₒᵤₜ) from the encoder. Through progressive upsampling (e.g., upsample by 2) and concatenation (Concat) operations, the decoder fuses high-level semantic information with low-level spatial detail information, ultimately producing a high-resolution output.

In some embodiments, compared to conventional methods that correct the main beam effect and the synthesized beam effect separately, the method provided in one or more embodiments of the present disclosure achieve unified correction, avoiding scenarios where the two effects interact during the correction process. The neural network model (i.e., the RpDH-Deeplab network model) exhibits good transferability after training is completed. The trained neural network model can accurately model the data, thereby enabling the extraction of main beam effect features. Due to the excellent generalization capability of the neural network model, the trained model remains applicable even to radio astronomical structures not included in the training dataset.

The foregoing describes only embodiments of the present disclosure, and well-known specific technical solutions and/or common knowledge in the art are not elaborated herein. It should be noted that those skilled in the art may make several modifications and improvements without departing from the technical solution of the present disclosure, and these should also be considered as falling within the protection scope of some embodiments of the present disclosure. None of these will affect the effects of implementing some embodiments of the present disclosure or the practical utility of the patent. The scope of protection sought by this application shall be defined by the content of the claims, and the descriptions in the detailed embodiments and other parts of the specification may be used to interpret the content of the claims.

What is claimed is:

1. A method for eliminating a coupling effect between a main beam and a synthesized beam in a radio interferometric array, comprising:
constructing a residual processing module RpDH-Deeplab to process an input image containing effects and obtaining information Fₒᵤₜ of the input image;
constructing an encoder within a segmentation network, wherein the encoder is configured to perform multi-level feature extraction on the input image through a backbone network MobileNet v2, and perform further feature extraction for a highest-level feature by using a DH-ASPP module to obtain DH-ASPPₒᵤₜ output from the DH-ASPP module;
constructing a decoder within the segmentation network, to fuse low-level features output from the encoder with the high-level feature DH-ASPPₒᵤₜ to obtain Decoderₒᵤₜ output from the decoder; and
combining the Fₒᵤₜ with the Decoderₒᵤₜ and using an activation function Tanh to obtain an output of a RpDH-Deeplab network, wherein parameters of the RpDH-Deeplab network are updated through a plurality of rounds of training, to correct a main beam effect and a synthesized beam effect based on the output of the RpDH-Deeplab network.

2. The method of claim 1, wherein the residual processing module includes two 3×3 convolutional layers and two feature extraction attention blocks, each of the two feature extraction attention blocks includes a feature extraction module and an attention module;
the feature extraction module employs 3×3 convolution for preliminary feature extraction on the information of the input image, and the information of the input image is preserved via a residual connection; and
the attention module includes a spatial attention module, a channel attention module, and a global average pooling module.

3. The method of claim 2, wherein an input feature Fᵢₙ to the attention module includes an output feature of the feature extraction module, and the obtaining information Fₒᵤₜ of the input image includes:
applying a spatial attention mechanism, a channel attention mechanism, and a hybrid attention mechanism to the Fᵢₙ, respectively, to obtain Fₛ, F_{c}, and F_{cs};
performing a global average pooling operation on the F_{cs} to obtain Fₚ;
multiplying the Fₚ with the F_{c} and the Fₛ respectively to obtain F_{cp} and Fₛₚ; and
multiplying the Fₛₚ with the Fᵢₙ, and then multiplying a result of the multiplication between the Fₛₚ and the Fᵢₙ with the F_{cp} to obtain the information Fₒᵤₜ of the input image.

4. The method of claim 1, wherein the segmentation network is improved based on a Deeplab v3+ network;
in the RpDH-Deeplab network, the MobileNet v2 is used as the backbone network for the segmentation network;
the MobileNet v2 employs an inverted residual block;
the MobileNet v2 is configured with four convolutional operations having a stride of 2;
contextual information of the input image is extracted via spatial pyramid pooling (SPP), and a dilated convolution operation is added to the SPP in the Deeplab v3+ network;
a hybrid dilated convolution (HDC) is incorporated into the RpDH-Deeplab network to extract features at different scales based on different dilation rates, and a dense connection is incorporated; and
a DH-ASPP network structure within the RpDH-Deeplab network is constructed by incorporating the dense connection and the HDC, based on an Atrous Spatial Pyramid Pooling (ASPP) module and characteristics of a radio astronomical structure.

5. The method of claim 4, wherein the MobileNet v2 is formed by stacking a plurality of inverted residual blocks; each inverted residual block is configured to:
perform a 1×1 convolution operation for dimension expansion;
perform a 3×3 depthwise separable convolution; and
perform a 1×1 convolution for dimension reduction.

6. The method of claim 4, wherein four changes in a feature size of the MobileNet v2 are 184×184, 92×92, 46×46, and 23×23, corresponding respectively to four features at the different scales: F₂, F₄, F₈, and F₁₆;
wherein the F₁₆ is the highest-level feature; in the RpDH-Deeplab network, the F₁₆ is input to the DH-ASPP module for further feature extraction, and the F₂, the F₄, and the F₈ are input to the decoder for feature fusion.

7. The method of claim 1, wherein:
the DH-ASPP module includes four hybrid dilated convolutions: Part-1, Part-2, Part-3, and Part-4; wherein
each of the four hybrid dilated convolutions consists of three dilated convolution modules, each of the three dilated convolution modules includes a convolutional layer, a batch normalization layer, and an activation function;
the dilated convolution modules are configured with different dilation rates to interrelate dilated convolution results.

8. The method of claim 7, wherein the DH-ASPP module further includes Part-5;
wherein the Part-5 is an Encoder-Decoder module (E-D) constructed by a pooling operation, a convolution operation, and an upsampling operation, to perform a final feature extraction, represented by the following formula:
$$DH - {ASPP}_{out} = Cat \{ {Conv}_{{L}_{1}} , {Conv}_{{L}_{2}} , {Conv}_{{L}_{3}} , {Conv}_{{L}_{4}} , E - D \} ,$$
$${Conv}_{{L}_{n}} = {Conv}_{{R}_{i 3}} ( {Conv}_{{R}_{i 2}} ( {Conv}_{{R}_{i 1}} ) ) ,$$
wherein Cat denotes a concatenation operation, Conv denotes a convolution operation, Conv_{L}_{ₙ} denotes an output feature map corresponding to a combination of the three dilated convolution modules within an n-th hybrid dilated convolution, Conv_{L}_{₁}, Conv_{L}_{₂}, Conv_{L}_{₃}, and Conv_{L}_{₄} denote output feature maps of the four hybrid dilated convolutions the Part-1, the Part-2, the Part-3, and the Part-4 in the DH-ASPP module, respectively, i₁, i₂, and i₃ denote three different dilation rates for each hybrid dilated convolution, and Conv_{R}_{ᵢ₁}, Conv_{R}_{ᵢ₂}, and Conv_{R}_{ᵢ₃} denote dilated convolution modules with the dilation rates i₁, i₂, and i₃, respectively.

9. The method of claim 1, wherein the decoder of the RpDH-Deeplab network is configured to capture contextual information at a same resolution as the input image for pixel-level segmentation;
the decoder is configured to fuse the low-level features output from the encoder with the high-level feature, the fusion process being represented as:
$${Decoder}_{out} = {U}_{N} ( Cat ( {F}_{2} , {U}_{2} ( Cat ( {F}_{4} , {U}_{4} ( Cat ( {F}_{8} , {U}_{8} ( {Encoder}_{out} ) ) ) ) ) ) ) ;$$
wherein Decoderₒᵤₜ denotes a final output of the decoder, F₂, F₄, and F₈ denote feature maps produced by the encoder at spatial downsampling factors of 2, 4, and 8 relative to the input image, respectively, U_{N}, U₂, U₄, and U₈ denote upsampling operations by factors of N, 2, 4, and 8, respectively, Cat denotes a concatenation operation, and Encoderₒᵤₜ denotes an output of the encoder.
